(19) United States
(12) Patent Application Publication
(10) Pub. No.: US 2011/0135995 A1
(43) Pub. Date: Jun. 9, 2011

(54) STACK TYPE ELECTRODE ASSEMBLY AND LITHIUM ION SECONDARY BATTERY HAVING THE SAME

(76) Inventor: Sooan Song, Yongin-si (KR)

(21) Appl. No.: 12/957,153

(22) Filed: Nov. 30, 2010

(30) Foreign Application Priority Data
Dec. 7, 2009 (KR) 10-2009-0120497

(51) Int. Cl. H01M 10/02

(52) U.S. Cl. 429/162

(57) ABSTRACT

A secondary battery includes an electrode assembly and a pouch housing the electrode assembly. The electrode assembly includes a first negative electrode collector plate having a first negative electrode non-coating portion, a first positive electrode collector plate having a first positive electrode non-coating portion and which is in correspondence with the first negative electrode collector plate, and a unit stack body between the first positive and negative electrode collector plates. The unit stack body includes a second positive electrode collector plate having a second positive electrode non-coating portion electrically connected to the first positive electrode non-coating portion, a second negative electrode collector plate having a second negative electrode non-coating portion electrically connected to the first negative electrode non-coating portion, and a separator disposed between the second positive and negative electrode collector plates. One end of the first negative and positive electrode non-coating portions protrude from the pouch.

### CROSS-REFERENCE TO RELATED APPLICATION

This application claims the benefit of Korean Patent Application No. 10-2009-0120497, filed Dec. 7, 2009 in the Korean Intellectual Property Office, the disclosure of which is incorporated herein by reference.

### BACKGROUND

1. Field

Example embodiments relate to a stack type electrode assembly and a lithium ion secondary battery having the same.

2. Description of the Related Art

A lithium ion secondary battery is categorized into a jelly-roll type electrode assembly, a stack type electrode assembly and a stack/folding type electrode assembly according to the structure of an electrode assembly. The jelly-roll type electrode assembly is formed by disposing a separator between a long sheet type of positive and negative electrode plates, and winding the long sheet in a jelly-roll shape in a state where the separator is interposed between the positive and negative electrode plates. The stack type electrode assembly is formed by sequentially stacking a plurality of positive and negative electrode plates, which are cut in units of a certain size, in a state where a separator is interposed. Moreover, the stack/folding type electrode assembly is formed by winding Bi-cells or full-cells in which a positive electrode plate and a negative electrode plate are stacked in a state where a separator is interposed, using a long continuous separator sheet.

In the case of a stack type lithium ion secondary battery, to form an electrode terminal, a process of welding a tab to positive and negative electrode plates and a process of welding the tab to an electrode terminal are performed. Accordingly, a process is complicated, and the material cost increases.

Moreover, a stack type lithium ion secondary battery uses an electrode plate in which active materials are coated on the both surfaces of a collector plate. Accordingly, since one surface of an electrode plate that is stacked at the uppermost portion or the lowermost portion does not have a positive electrode or a negative electrode that is symmetric, an undesired coating layer is formed. The undesired coating layer slightly participates in charge or discharge by the diffusion of lithium ions. Accordingly, the capacity of a battery may be lost.

A secondary battery is further divided into a prismatic type, a cylinder type and a pouch type according to the shapes of a case that receives the electrode assembly. Since a pouch type lithium ion secondary battery has the exterior that is formed with a thin pouch membrane, it is vulnerable to external impacts unlike a can type lithium secondary battery having more solid sides.

### SUMMARY

Embodiments are directed to a stack type electrode assembly and a secondary battery including the same.

It is an embodiment to provide a stack type electrode assembly and a lithium secondary battery including the same, which simplify a process of forming electrode terminals.

It is a feature of another embodiment to provide a stack type electrode assembly and a lithium secondary battery including the same, which removes undesired coating portions formed on electrode plates that are stacked at the uppermost portion and the lowermost portion.

It is a feature of another embodiment to provide a stack type electrode assembly and a lithium secondary battery including the same, which increases the exterior intensity of a battery.

According to an aspect of the invention, a secondary battery includes: an electrode assembly including a first negative electrode collector plate in which a first negative electrode non-coating portion is included at one side and which is disposed at a lowermost portion, a first positive electrode collector plate in which a first positive electrode non-coating portion is included at one side and which is disposed at an uppermost portion in correspondence with the first negative electrode collector plate, and a unit stack body which includes a separator and is stacked at least one or more times at an upper portion and a lower portion between the first negative electrode collector plate and the firs positive electrode collector plate; and a container receiving the electrode assembly, wherein the unit stack body has a shape in which a second positive electrode collector plate where a second positive electrode non-coating portion electrically connected to the first positive electrode non-coating portion is included at one side, a separator and a second negative electrode collector plate where a second negative electrode non-coating portion electrically connected to the first negative electrode non-coating portion is included at one side, and a one end of the first negative electrode non-coating portion and a one end of the first positive electrode non-coating portion protrude from a one end of the container to an outer side.

According to an aspect of the invention, the second negative electrode non-coating portion may be attached to the first negative electrode non-coating portion.

According to an aspect of the invention, the second positive electrode non-coating portion may be attached to the first positive electrode non-coating portion.

According to an aspect of the invention, the first negative electrode non-coating portion may include a first insulation tape in a region which contacts the container.

According to an aspect of the invention, the first positive electrode non-coating portion may include a second insulation tape in a region which contacts the container.

According to an aspect of the invention, negative electrode active materials may be coated at a top and bottom of the second negative electrode collector plate.

According to an aspect of the invention, positive electrode active materials may be coated at a top and bottom of the second positive electrode collector plate.

According to an aspect of the invention, negative electrode active materials may be coated at a top of the first negative electrode collector plate.

According to an aspect of the invention, the first negative electrode collector plate may be formed thicker than the second negative electrode collector plate by a thickness of negative electrode active materials that are coated at a bottom of the second negative electrode collector plate.

According to an aspect of the invention, the thickness of the first negative electrode collector plate may be about 50 μm to 100 μm.

According to an aspect of the invention, the positive electrode active materials may be coated at a bottom of the first positive electrode collector plate.

According to an aspect of the invention, the first positive electrode collector plate may be formed thicker than the second positive electrode collector plate by a thickness of positive electrode active materials that are coated at a top of the second positive electrode collector plate.

According to an aspect of the invention, the thickness of the first positive electrode collector plate may be about 50 μm to 100 μm.

According to an aspect of the invention, a stack type electrode assembly includes a first negative electrode collector plate in which a first negative electrode non-coating portion is included at one side and which is disposed at a lowermost portion, a first positive electrode collector plate in which a first positive electrode non-coating portion is included at one side and which is disposed at an uppermost portion in correspondence with the first negative electrode collector plate, and a unit stack body which includes a separator and is stacked at least one or more times at an upper portion and a lower portion between the first negative electrode collector plate and the firs positive electrode collector plate, wherein the unit stack body has a shape in which a second positive electrode collector plate where a second positive electrode non-coating portion electrically connected to the first positive electrode collector plate is included at one side, a separator and a second negative electrode collector plate where a second negative electrode non-coating portion electrically connected to the first negative electrode non-coating portion is included at one side.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a view of an assembled state of a lithium ion secondary battery according to an embodiment;

FIG. 2 illustrates an exploded perspective view of a lithium ion secondary battery according to an embodiment;

FIG. 3 illustrates a cross-sectional view taken along line X-X′ of FIG. 1;

FIG. 4 illustrates a cross-sectional view taken along line Y-Y′ of FIG. 1;

FIG. 5A illustrates a perspective view of a first negative electrode plate in FIG. 2;

FIG. 5B illustrates a perspective view of a first negative electrode collector plate in FIG. 2;

FIG. 6A illustrates a perspective view of a second negative electrode plate in FIG. 2;

FIG. 6B illustrates a perspective view of a second negative electrode collector plate in FIG. 2;

FIG. 7A illustrates a perspective view of a first positive electrode plate in FIG. 2;

FIG. 7B illustrates a perspective view of a first positive electrode collector plate in FIG. 2;

FIG. 8A illustrates a perspective view of a second positive electrode plate in FIG. 2; and

FIG. 8B illustrates a perspective view of a second positive electrode collector plate in FIG. 2.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

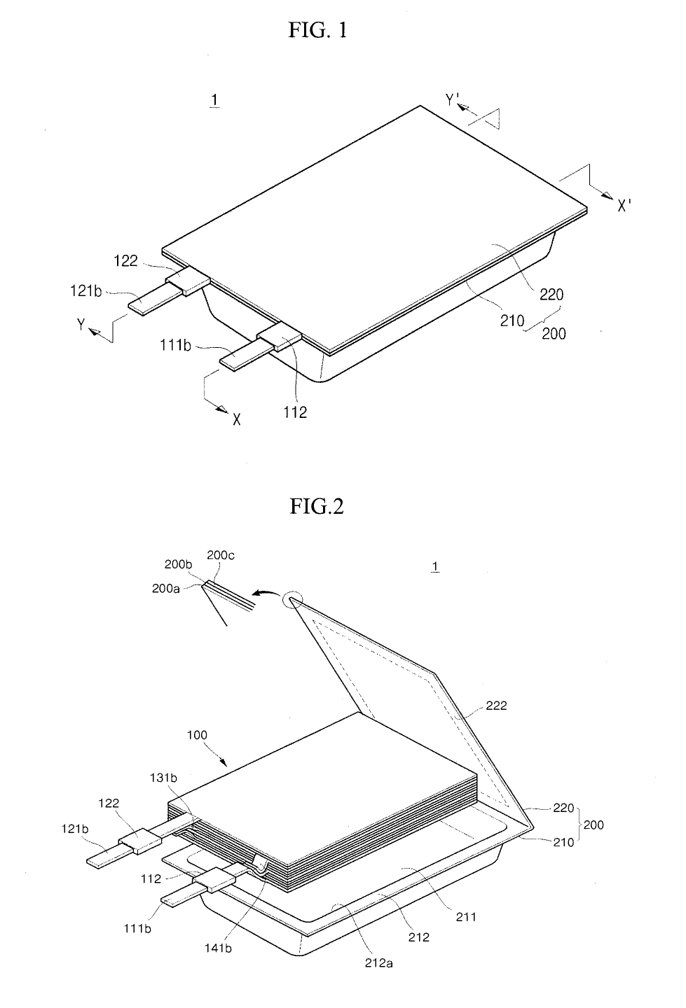

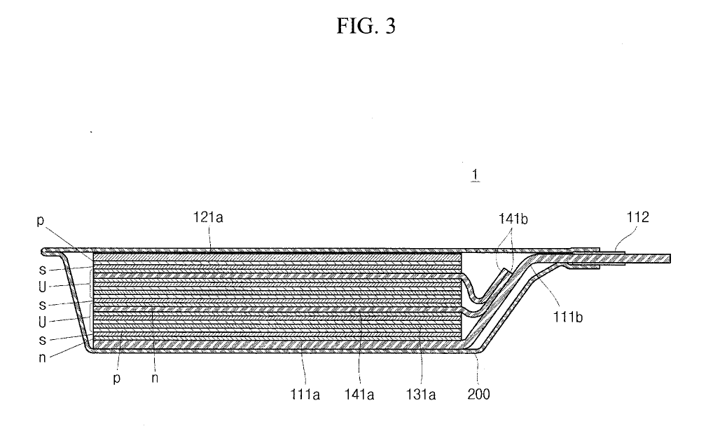

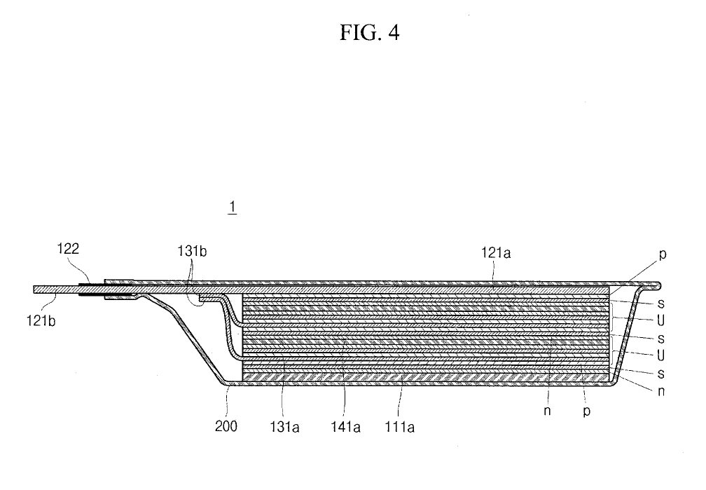

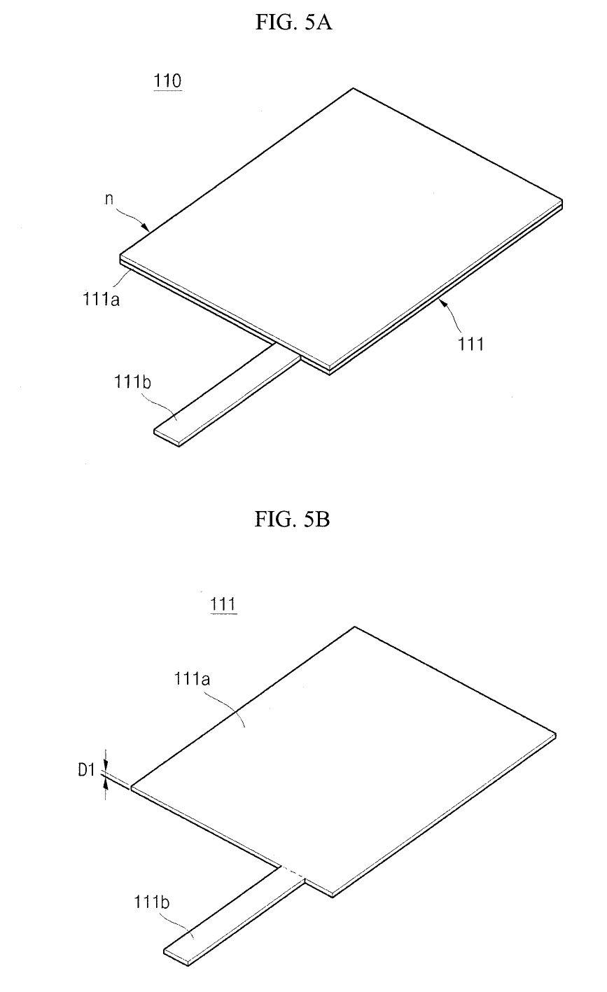

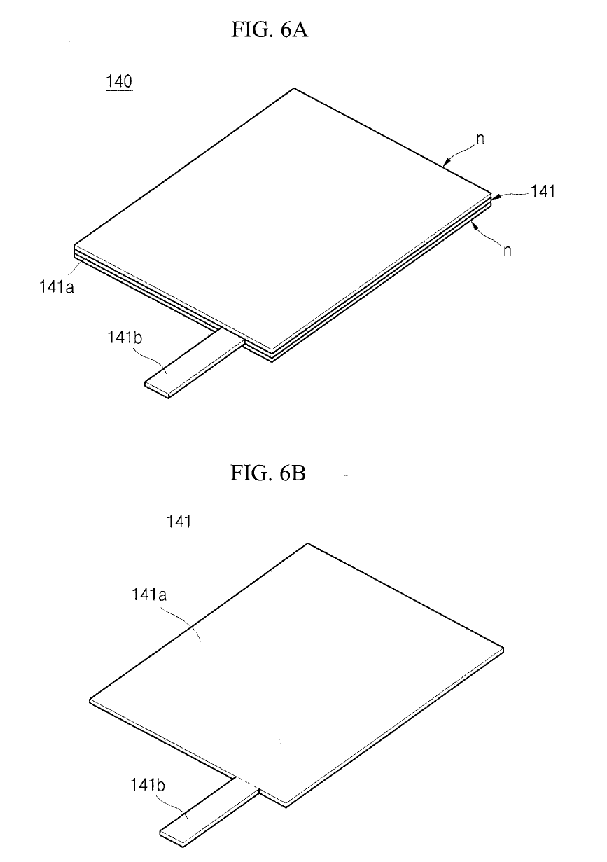

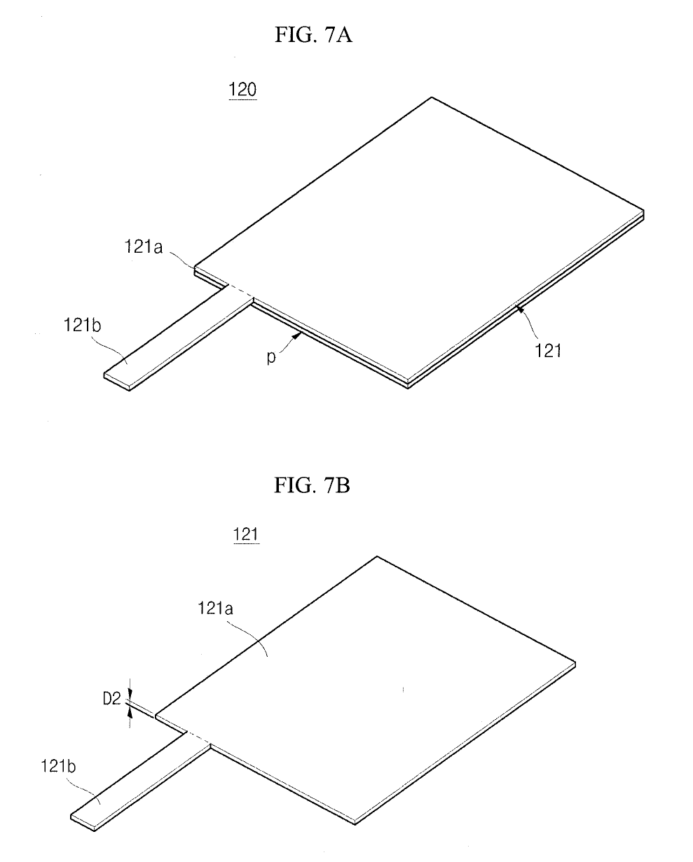

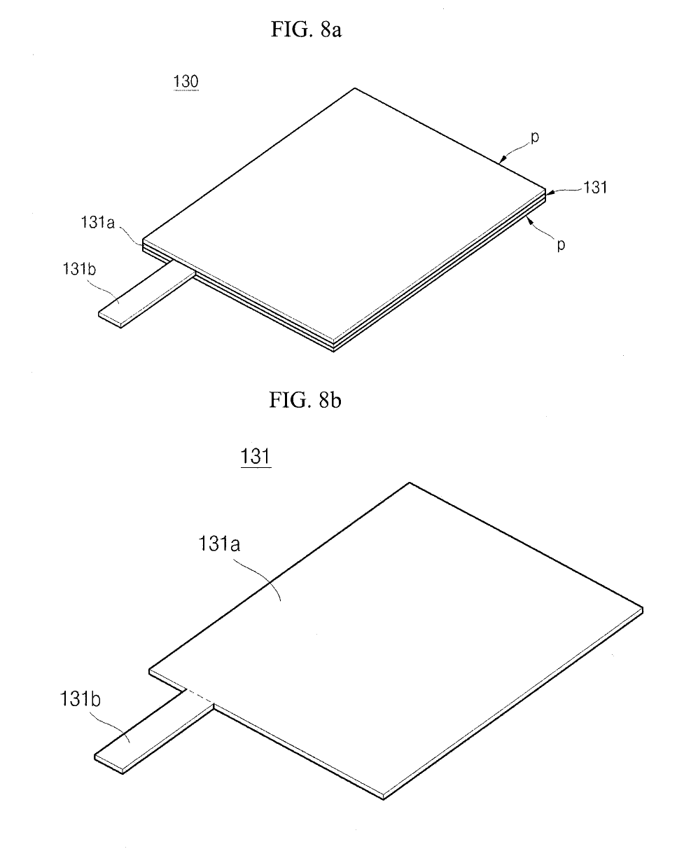

Hereinafter, embodiments will be described in detail with reference to FIGS. 1 through 8B. FIG. 1 illustrates a view of an assembled state of a lithium ion secondary battery 1 according to an embodiment. FIG. 2 illustrates an exploded perspective view of the lithium ion secondary battery 1 according to an embodiment. FIG. 3 illustrates a cross-sectional view taken along line X-X′ of FIG. 1. FIG. 4 illustrates a cross-sectional view taken along line Y-Y′ of FIG. 1. FIG. 5A illustrates a perspective view of a first negative electrode plate 110 in FIG. 2. FIG. 5B illustrates a perspective view of a first negative electrode collector plate 111 in FIG. 2. FIG. 6A illustrates a perspective view of a second negative electrode plate 140 in FIG. 2. FIG. 6B illustrates a perspective view of a second negative electrode collector plate 141 in FIG. 2. FIG. 7A illustrates a perspective view of a first positive electrode plate 120 in FIG. 2. FIG. 7B illustrates a perspective view of a first positive electrode collector plate 121 in FIG. 2. FIG. 8A illustrates a perspective view of a second positive electrode plate 130 in FIG. 2. FIG. 8B illustrates a perspective view of a second positive electrode collector plate 131 in FIG. 2. While described in terms of a lithium ion secondary battery 1, it is understood that aspects of the invention can be used with other battery types.

A portion of elements will first be described for clarifying the important points of embodiments before the description of embodiments. First, in the figures, negative electrode active materials are marked with the letter ‘n’ irrespective of a coated position. Negative electrode active materials ‘n’ may be formed of carbon, for example, hard carbon and graphite-based carbon. In the figures, positive electrode active materials are marked with the letter ‘p’ irrespective of a coated position. Positive electrode active materials may be formed of a layered compound such as LiCoO2 or LiNiO2, or a compound for which one or more transition metals are substituted. In the figures, a separator is marked with the letter ‘s’ irrespective of a coated position. The separator ‘s’ may use an insulating thin film having high ion transmittance and mechanical strength. The separator ‘s’ may be formed of olefin-based polymer, for example, polypropylene or polyethylene having chemical resistance and hydrophobicity. The separator may be impregnated with an electrolyte, or the electrolyte can be separately added to the battery.

Hereinafter, the configuration of embodiments will be described in detail. Referring to FIGS. 1 through 8B, the lithium ion battery 1 according to an embodiment includes an electrode assembly 100 and a pouch 200 (e.g. container). While shown with pouch 200 by way of example, it is understood the electrode assembly 100 could be housed in any type of container.

The electrode assembly 100 includes a first negative electrode plate 110, a first positive electrode plate 120, a unit stack body ‘U’ and a separator ‘s’. The first negative electrode plate 110 includes a first negative electrode collector plate 111, negative electrode active materials ‘n’, and a first insulation tape 112. The first negative electrode plate 110 is disposed at the lowermost portion of the electrode assembly 100.

The first negative electrode collector plate 111 includes a first negative electrode coating portion 111a and a first negative electrode non-coating portion 111b. As shown, the first negative electrode non-coating portion 111b is made from the same plate as the first negative electrode coating portion 111a and has a same thickness as the first negative electrode coating portion 111a The first negative electrode coating portion 111a is a region of the first negative electrode collector plate 111 on which the negative electrode active materials ‘n’ are coated. In the first negative electrode coating portion 111a, the negative electrode active materials ‘n’ may be coated only on one side, such as the top as shown. The first negative electrode coating portion 111a may be formed thicker than a second negative electrode coating portion 141a by the thickness of the negative electrode active materials “n” that are coated at the bottom of the second negative electrode coating portion 141a. Accordingly, the thickness of the first negative electrode coating portion 111a may be about 50 μm to 100 μm.

When the thickness D1′ of the first negative electrode coating portion 111a is less than about 50 μm, the internal resistance of the battery increases 1, and thus the cycle life of the battery 1 can be shortened. Moreover, when the thickness of the first negative electrode coating portion 111a exceeds about 100 μm, the negative electrode active materials ‘n’ are not correctly coated. By coating the negative electrode active materials ‘n’ only at one surface of the first negative electrode collector plate 111a, an undesired coating layer is not formed. By thickly forming the first negative electrode collector plate 111 in proportion to a volume that is obtained by removing the undesired coating layer, moreover, the exterior strength of the battery may increase and the internal resistance of the battery may decrease.

The first negative electrode non-coating portion 111 b is a region of the first negative electrode collector plate 111 on which the negative electrode active materials ‘n’ are not coated. The first negative electrode non-coating portion 111b may have a certain width and be extended from the one end of the first negative electrode coating portion 111a to an outer side. The one end of the first negative electrode non-coating portion 111b may protrude from the one end of the pouch 200 to an outer side. As shown, the non-coating portion 111b protrudes from the first negative electrode coating portion 111a and has a width that is less than the first negative electrode coating portion 111a. Accordingly, the first negative electrode non-coating portion 111b may serve as a negative terminal.

The first insulation tape 112 is formed at a region in which the first negative electrode non-coating portion 111b contacts the pouch 200. The first insulation tape 112 can prevent short between metal layers that form the first negative electrode non-coating portion 111b and the pouch 200.

The first positive electrode plate 120 includes a first positive electrode collector plate 121, positive electrode active materials ‘p’, and a second insulation tape 122. As shown, the first positive electrode plate 120 is disposed at the uppermost portion of the electrode assembly 100.

The first positive electrode collector plate 121 includes a first positive electrode coating portion 121a and a first positive electrode non-coating portion 121b. The first positive electrode coating portion 121a is a region of the first positive electrode collector plate 121 in which the positive electrode active materials ‘p’ are coated. While not required in all aspects, the total area of the first positive electrode coating portion 121a may face the total area of the first negative electrode coating portion 111a as shown. In the first positive electrode coating portion 121a, the positive electrode active materials ‘p’ is coated only on one side which faces the first negative electrode coating portion 111a, such as a bottom as shown.

The first positive electrode coating portion 121a may be formed thicker than a second positive electrode coating portion 131a by the thickness of positive electrode active materials “p” that are coated at the top of the second positive electrode coating portion 131a. Accordingly, the thickness of the first positive electrode coating portion 121a may be about 50 μm to 100 μm. When the thickness ‘D2’ of the first positive electrode coating portion 121a is less than about 50 μm, the internal resistance of a battery increases, and thus the cycle life of the battery can be shortened. Moreover, when the thickness of the first positive electrode coating portion 121a exceeds about 100 μm, the positive electrode active materials ‘p’ are not correctly coated. By coating the positive electrode active materials ‘p’ only at one surface of the first positive electrode collector plate 121a, an undesired coating layer is not formed. By thickly forming the first positive electrode collector plate 121 in proportion to a volume that is obtained by removing the undesired coating layer, moreover, the exterior intensity can increase (i.e., the thickness improves the protection of the electrode assembly 100 against external impacts) and internal resistance decreases.

The first positive electrode non-coating portion 121b is a region of the first positive electrode collector plate 121 on which the positive electrode active materials ‘p’ are not coated. The first positive electrode non-coating portion 121b may have the same width as that of the first negative electrode non-coating portion 111b and be extended from the one end of the first positive electrode coating portion 121a to an outer side as shown, but the invention is not limited thereto. The first positive electrode non-coating portion 121b may be separated from the first negative electrode non-coating portion 111b in a horizontal direction (i.e., a direction of the width of the plates 111, 121). The one end of the first positive electrode non-coating portion 121b protrudes from the one end of the pouch 200 to an outer side. Accordingly, the first positive electrode non-coating portion 121b may serve as a positive terminal.

The second insulation tape 122 is formed at a region in which the first positive electrode non-coating portion 121b contacts the pouch 200. The second insulation tape 122 can prevent short between metal layers that form the first positive electrode non-coating portion 121b and the pouch 200.

The shown unit stack body ‘U’ includes a second positive electrode plate 130, a second negative electrode plate 140, and a separator ‘s’. The shown unit stack body ‘U’ has the second positive electrode plate 130, the separator ‘s’ and the second negative electrode plate 140 sequentially stacked. The unit stack body ‘U’ includes the separator ‘s’ and is stacked at least one or more times in an upper portion and a lower portion, between the first negative electrode plate 110 and the first positive electrode plate 120. That is, in an embodiment, the electrode assembly 1 has the first negative plate 110, the separator ‘s’, the unit stack body ‘U’, the separator ‘s’, the unit stack body ‘U’, the separator ‘s’ and the first positive electrode plate 120 sequentially stacked. When the unit stack body ‘U’ is stacked three times, the first negative plate 110, the separator ‘s’, the unit stack body ‘U’, the separator ‘s’, the unit stack body ‘U’, the separator ‘s’, the unit stack body ‘U’, the separator ‘s’ and the first positive electrode plate 120 are sequentially stacked. As such, the number of stack bodies “U” is not limited to the shown number.

The second positive electrode plate 130 includes a second positive electrode collector plate 131 and the positive electrode active materials ‘p’. The second positive electrode collector plate 131 includes a second positive electrode coating portion 131a and a second positive electrode non-coating portion 131b. The second positive electrode coating portion 131a is a region of the second positive electrode collector plate 131 on which the positive electrode active materials ‘p’ are coated. While not required in all aspects, the total area of the second positive electrode coating portion 131a faces the total area of the first negative electrode coating portion 111a on one side and the total area of a second negative electrode coating portion 141a on the other side or the total area of the second negative electrode coating portion 141a on each side. In the second positive electrode coating portion 131a, the positive electrode active materials ‘p’ are coated at a top and a bottom.

The second positive electrode non-coating portion 131b is a region of the second positive electrode collector plate 131 in which the positive electrode active materials ‘p’ are not coated. The second positive electrode non-coating portion 131b may have the same width as that of the first positive electrode non-coating portion 121b and be extended from the one end of the second positive electrode coating portion 131a to an outer side, but the invention is not limited thereto. The second positive electrode non-coating portion 131b may be disposed just under the first positive electrode non-coating portion 121b as shown, but the invention is not limited thereto.

The second positive electrode non-coating portion 131b may electrically be connected to the first positive electrode non-coating portion 121b. The one side of the second positive electrode non-coating portion 131b may be attached to the first positive electrode non-coating portion 121b in a process such as ultrasonic welding, resistance welding or laser welding. Consequently, the first positive electrode plate 120 and the second positive electrode plate 130 may be connected in parallel.

The second negative electrode plate 140 includes a second negative electrode collector plate 141 and the negative electrode active materials ‘n’. The second negative electrode collector plate 141 includes a second negative electrode coating portion 141a and a second negative electrode non-coating portion 141b. The second negative electrode coating portion 141a is a region of the collector plate 141 on which the negative electrode active materials ‘n’ are coated. In the second negative electrode coating portion 141a, the negative electrode active materials ‘n’ is coated on both sides (i.e., at a top and a bottom). The total area of the second negative electrode coating portion 141 a may face the total area of the second positive electrode coating portion 131a on one side and the total area of another second positive electrode coating portion 131a on the other side or the total area of the second positive electrode coating portion 131a on one side and the total area of the first positive electrode coating portion 121a on the other side.

The second negative electrode non-coating portion 141b is a region of the collector plate 141 on which the negative electrode active materials ‘n’ are not coated. The second negative electrode non-coating portion 141b may have the same width as that of the first negative electrode non-coating portion 141b and be extended from the one end of the second negative electrode coating portion 141a to an outer side, but the invention is not limited thereto. The second negative electrode non-coating portion 141b may be separated from the second positive electrode non-coating portion 131b in a horizontal direction, as shown. The second negative electrode non-coating portion 141b may be disposed just under the first negative electrode non-coating portion 111b, but the invention is not limited thereto.

The second negative electrode non-coating portion 141b may electrically be connected to the first negative electrode non-coating portion 111b. The one side of the second negative electrode non-coating portion 141b may be attached to the first negative electrode non-coating portion 111b in a process such as ultrasonic welding, resistance welding or laser welding. Consequently, the first negative electrode plate 110 and the second positive electrode plate 130 may be connected in parallel.

The shown pouch 200 includes a Casted Polypropylene (CPP) layer 200a, a metal thin film 200b, and a dielectric layer 200c. The CCP layer 200a, the metal thin film 200b and the dielectric layer 200c may be sequentially stacked with respect to an inner side in which the electrode assembly 100 is received. The CCP layer 200a is formed of composite materials of organic materials and inorganic materials. However, the type of pouch 200 or other case is not limited to the shown example.

The metal thin film 200b may be formed of aluminum. The dielectric layer 200c may be formed of nylon. The center of the pouch 200 may be collapsed and thereby have a lower portion 210 and an upper portion 220. The inside of the pouch 200 maintain sealing by the junction of the lower portion 210 and upper portion 220.

The lower portion 210 of the pouch 200 may include an accommodation portion 211 and a lower sealing portion 212. An accommodation groove 211 may be formed by pressing the lower portion 210 of the pouch 200, and accommodates the electrode assembly 100.

The lower sealing portion 212 extends from the upper side 211a of the accommodation groove 211 to an outer side and be thereby formed.

An upper sealing portion 222 is formed at a region corresponding to the lower sealing portion 211, in the upper portion 220 of the pouch 200. The upper sealing portion 222 is attached to the lower sealing portion 212 through heating and pressing, and thus the sealing of the inside of the pouch 200 can be kept. According to the stack type electrode assembly and the lithium ion secondary battery, by using the first negative electrode non-coating portion and the first positive electrode non-coating portion as the electrode terminal, a process of forming the electrode terminal can be simplified, and the cost can be saved.

The electrode plates 111, 121, 131, 141 can be made of any current collector material, such as aluminum, copper or other metal foils. Further, the non-coating portions 111b, 121b, 131b, 141b can be formed by cutting or stamping the current collector material to form separate coating portions 111a, 121a, 131a, 141a and non-coating portions 111b, 121b, 131b, 141b from a corresponding single piece of the current collector material. Also, while shown as having a constant thickness between the coating portions 111a, 121a, 131a, 141a and non-coating portions 111b, 121b, 131b, 141b, it is understood that the coating portions 111a, 121a, 131a, 141a could have a different thickness as compared to the non-coating portions 111b, 121b, 131b, 141b.

According to the stack type electrode assembly and the lithium ion secondary battery, since the negative electrode active materials or the positive electrode active materials are coated only on one surface of the first negative electrode coating portion and one surface of the first positive electrode coating portion, undesired active materials are not formed. Accordingly, the capacity of the battery can be improved, and the cost can be saved.

According to the stack type electrode assembly and the lithium ion secondary battery, by thickly forming the first negative electrode collector plate and the first positive electrode collector plate in proportion to a volume that is obtained by removing the undesired active materials, exterior intensity can increase and the electrode assembly is better able to withstand external impacts.

According to the stack type electrode assembly and the lithium ion secondary battery, since the first negative electrode collector plate and the first positive electrode collector plate are thick, internal resistance decreases.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery comprising:
an electrode assembly comprising:
a first negative electrode collector plate having a first negative electrode non-coating portion at one side and which is disposed at an outermost portion of the electrode assembly,
a first positive electrode collector plate having a first positive electrode non-coating portion at one side and which is disposed at another outermost portion of the electrode assembly and corresponds to the first negative electrode collector plate, and
a unit stack body which comprises at least one stack between the first negative and positive electrode collector plates; and
a container receiving the electrode assembly,
wherein:
each stack of the unit stack body includes:
a second positive electrode collector plate having a second positive electrode non-coating portion electrically connected to the first positive electrode non-coating portion,
a second negative electrode collector plate having a second negative electrode non-coating portion electrically connected to the first negative electrode non-coating portion, and
a separator between the second positive and negative electrode collector plates, and
at least a portion of the first negative electrode non-coating portion and at least a portion of the first positive electrode non-coating portion protrude through one end of the container.

2. The secondary battery as claimed in claim 1, wherein a portion of the second negative electrode non-coating portion contacts a portion of the first negative electrode non-coating portion and a portion of the second positive electrode non-coating portion contacts a portion of the first positive electrode non-coating portion.

3. The secondary battery as claimed in claim 1, further comprising a first insulation tape at a region of the first negative electrode non-coating portion which contacts the container and a second insulation tape at a region of the first positive electrode non-coating portion which contacts the container.

4. The secondary battery as claimed in claim 1, further comprising negative electrode active materials coated at a first side and a second side of the second negative electrode collector plate and positive electrode active materials coated at a first side and a second side of the second positive electrode collector plate.

5. The secondary battery as claimed in claim 1, wherein negative electrode active materials are coated at a first side of the first negative electrode collector plate.

6. The secondary battery as claimed in claim 5, wherein:
the negative electrode active materials are coated at a second side of the second negative electrode collector plate, and
the first negative electrode collector plate is thicker than the second negative electrode collector plate by a thickness of the negative electrode active materials coated at the second side of the second negative electrode collector plate.

7. The secondary battery as claimed in claim 6, wherein a thickness of the first negative electrode collector plate is at or between about 50 μm and 100 μm.

8. The secondary battery as claimed in claim 1, wherein positive electrode active materials are coated at a second side of the first positive electrode collector plate.

9. The secondary battery as claimed in claim 8, wherein:
the positive electrode active materials are coated at a first side of the second positive electrode collector plate, and
the first positive electrode collector plate is thicker than the second positive electrode collector plate by a thickness of the positive electrode active materials coated at the top of the second positive electrode collector plate.

10. The secondary battery as claimed in claim 9, wherein a thickness of the first positive electrode collector plate is at or between about 50 μm and 100 μm.

11. The secondary battery as claimed in claim 1, wherein one end of each of the first and second non-coated portions extend outside of the container and supply energy from the battery to a connectable external load.

12. The secondary battery of claim 1, wherein:
the first negative electrode collector plate has a first active material coated on a side of the first coated portion facing the separator and does not include the first active material on an opposite side of the first coated portion facing the container, and
the first positive electrode collector plate has a second active material coated on a side of the second coated portion facing the separator and does not include the second active material on an opposite side of the second coated portion facing the container.

13. The secondary battery as claimed in claim 1, wherein the outermost portion of the electrode assembly is the lowermost portion of the electrode assembly and the another outermost portion of the electrode assembly is the uppermost portion of the electrode assembly.

14. An electrode assembly, comprising:
a first negative electrode collector plate comprising a first negative electrode non-coating portion at one side and which is disposed at a lowermost portion of the electrode assembly;
a first positive electrode collector plate comprising a first positive electrode non-coating portion at one side and which is disposed at an uppermost portion of the electrode assembly and corresponds to the first negative electrode collector plate; and
a unit stack body which comprises at least one stack disposed between the first negative and positive electrode collector plates, the at least one stack comprising
a second positive electrode collector plate having a second positive electrode non-coating portion electrically connected to the first positive electrode collector plate,
a second negative electrode collector plate having a second negative electrode non-coating portion electrically connected to the first negative electrode non-coating portion, and
a separator disposed between the second positive and negative electrode collector plates.
